(19) United States
(12) Patent Application Publication
(10) Pub. No.: US 2021/0312570 A1
(43) Pub. Date: Oct. 7, 2021

(54) Real earnings

(71) Applicant: Michael Neff, San Jose, CA (US)

(72) Inventor: Michael Neff, San Jose, CA (US)

(21) Appl. No.: 16/838,203

(22) Filed: Apr. 2, 2020

(51) Int. Cl. G06Q 40/00; G06Q 50/26

(52) U.S. Cl. CPC G06Q 40/125; G06Q 50/26

(57) ABSTRACT

The purpose in this patent is to create greater buying power for the public, and to give companies an opportunity to make better selling or financing decisions, based on the idea I'm proposing.

Allow public to get approved for products or services that they seek, by being reviewed with more accurate information from the company depending on their method of approval

IE; Allowing people to not be denied for making too much money based off their gross wages instead of there actual earnings.

### PROCESS OF USING THIS SYSTEM

I want to create a partnership with company's that define people based off their gross wages
Unemployment Office
Housing
Child support office

Where people will pay my company for a membership to get them approval based on their real earnings and in return I'll pay these companies a percentage to grant these approvals.

1. Allow the public to truly benefit from what they earn, this patent only applies to a new method of granting the population, the things they need by a number they already provided.
